(19) United States
(12) Patent Application Publication
(10) Pub. No.: US 2012/0286774 A1
(43) Pub. Date: Nov. 15, 2012

(54) APPARATUS AND METHOD FOR DETERMINING STEERING ANGLE

(76) Inventors: Oliver Nehls, Canton, MI (US); Lodewijk Wijffels, Canton, MI (US); Sergio Codonesu, Heerlen (NL); Peter W.A. Zegelaar, Heerlen (NL)

(21) Appl. No.: 13/468,197

(22) Filed: May 10, 2012

(30) Foreign Application Priority Data
May 11, 2011 (DE) 102011075635.3

(51) Int. Cl. G01B 7/30; G01D 5/34

(52) U.S. Cl. 324/207.25; 33/1 PT; 250/231.13

(57) ABSTRACT

A steering angle sensor having a first part engaged to and rotatable with a steering system and a second part providing a code. The second part immovably engages the steering system and the first part rotates about the second part to scan the code. An electrical connection between the steering system and the second part transmits an output signal upon the first part scanning the code, the output signal being representative of a steering angle.

### CROSS REFERENCE

The inventive subject matter is a continuation of German Patent Application No. DE 102011075635.3, filed May 11, 2011 entitled “Apparatus for Determining the Steering Angle of a Steering Wheel and a Steering Column Module Equipped Therewith”, the entire disclosure of which is incorporated by reference into the present disclosure and provides the basis for a claim of priority of invention under 35 U.S.C. §119.

### TECHNICAL FIELD

The disclosures made herein relate generally to an apparatus and method for determining a steering angle of a steering wheel of a motor vehicle.

### BACKGROUND

Steering angle sensors are devices that are used to determine a steering angle of a steering wheel in a motor vehicle. Typically, steering angle sensors are rotary encoders having two parts. A first part of the sensor is a stator which is fixed, and formed by a housing, or a holder. A second part of the sensor is a rotor. The rotor is typically attached to the steering wheel or to a steering column of the motor vehicle and is mounted rotatably.

Rotary encoders may be analog or digital and are normally used to precisely determine the rotational angle or steering angle. Digital angle sensors are typically comprised of a coded device and a sensor scanning the coding. In prior art sensors, the coded device and the sensor rotate in relation to one another. In digital incremental rotary encoders, the coded device is typically a code disc or a code wheel having homogenous markings which are uniformly distributed over the circumference of the disc or wheel. The encoder rotates and markings are detected by the sensor and are signaled by an output of corresponding pulses. Successive pulses are counted according to the direction of rotation so as to establish the resultant rotational angle from the accumulated sum of pulses. In order to determine an actual position, a reference position setting is required. The counts refer to this reference position. This reference position is normally made known by a separate reference or zero mark detectable by the sensor.

In contrast, for digital, absolute rotary encoders the coding is position-dependent so that, for each angular position, an individual signal may be produced which directly and unambiguously indicates the relevant position. Identical regular positions within successive complete revolutions cannot be distinguished geometrically from one another, which is why additional measures have to be taken where necessary.

For these types of encoders, the steering angle is determined using a code disc or code wheel embodied as a rotor, wherein the sensor or scanning device is connected of the stator. Rotation of the steering wheel effects a corresponding rotation of the code disc, which is detected by the fixed sensor and is provided in the form of a corresponding electrical signal, from which the steering angle can be established.

For example, a steering wheel sensor is known from DE 101 10 785 A1 which is a rotatably mounted code disc reproducing the rotational angle of the steering wheel, and also a fixed scanning unit, which scans the code of the code discs, for determining the angular position of the steering wheel or steering column within a revolution. The described steering angle sensor additional has a counting unit, coupled mechanically to the steering column or code disc, for counting the complete revolutions of the steering wheel or steering column in relation to a zero position.

EP 1 069 026 B1 discloses a steering column module for a motor vehicle which comprises a signal cassette for transmitting information and/or electric currents between a steering wheel and the motor vehicle by way of a broadband cable designed as a flat spiral spring, a steering angle sensor and at least one steering column switch. The steering angle sensor comprises a rotatably mounted code disc which is connected in a rotationally engaged manner to a part of the signal transmission cassette rotatable with the steering wheel of the motor vehicle. An immobile scanning device, which consists substantially of a light emitter and a light receiver, is arranged in a printed circuit board, which is stationary in relation to the code disc in a housing of the steering column module.

When the steering angle information output by the stator-side scanning device or the sensor is required in the steering wheel, for the devices described above, the steering angle signal available at the stator must be transmitted by way of a normally spirally wound, flexible electrical conductor, also referred to as a “clockspring” or flat spiral spring, connecting the steering wheel to the electrical supply system of the motor vehicle. However, the spiral conductor has a negative effect on the signal transmission quality, in particular with high refresh or data rates, high precision and/or high currents on the spiral conductor, since the spiral conductor acts, in a manner know per se, as an electric coil (choke) for the signals to be transmitted.

Based on this, an object of the inventive subject matter is to present an apparatus for determining the steering angle of a steering wheel, particularly for motor vehicles, and a steering column module which allow the provision of steering angle information in the steering wheel with high refresh and data rates, high precision and/or high load current, having a low spatial requirement and is easy to install.

### SUMMARY

An apparatus for determining the steering wheel angle of a steering wheel of a motor vehicle having a code carrier and at least one scanning device for scanning a code provided on the code carrier. When the steering angle changes, the code carrier and the scanning device are rotatable with respect to one another and the scanning device produces an output signal, from which the steering angle may be established. The code carrier is immobile and the scanning device is coupled to the steering wheel or steering column in a rotatable and rotationally engaged manner.

A code carrier, which may be a code disc or a code wheel, and an associated device for scanning the code are understood to be any assemblies movable in relation to one another which produce an output signal owing to a relative movement, on the basis of which the extent of the rotational movement of the scanning device in relation to the code carrier provided with the code may be established. An example scanning arrangement may be, the change in an electrical resistance occurring in the event of a rotation of the corresponding scanning device may be determined, such as by a potentiometer which forms the code in the form of an electrical resistance and forms the associated scanning device in the form of a tap. In addition to this scanning arrangement, a magnetic measuring principle based on the Hall effect or an optical measuring principle based on the scanning of defined markings distributed on the code carrier may also be used.

### DESCRIPTION OF DRAWINGS

FIG. 1 is a view of an electrically assisted power steering system having a steering column module that incorporates the steering angle sensor and method of sensing steering angle according to the inventive subject matter; and

FIG. 2 is a view of the components of the steering angle sensor of the inventive subject matter implemented on the steering column.

Elements and steps in the figures are illustrated for simplicity and clarity and have not necessarily been rendered according to any particular sequence. For example, steps that may be performed concurrently or in different order are illustrated in the figures to help to improve understanding of embodiments of the inventive subject matter.

### DESCRIPTION OF INVENTION

While various aspects of the inventive subject matter are described with reference to a particular illustrative embodiment, the invention is not limited to such embodiments, and additional modifications, applications, and embodiments may be implemented without departing from the inventive subject matter. In the figures, like reference numbers will be used to illustrate the same components. Those skilled in the art will recognize that the various components set forth herein may be altered without varying from the scope of the inventive subject matter.

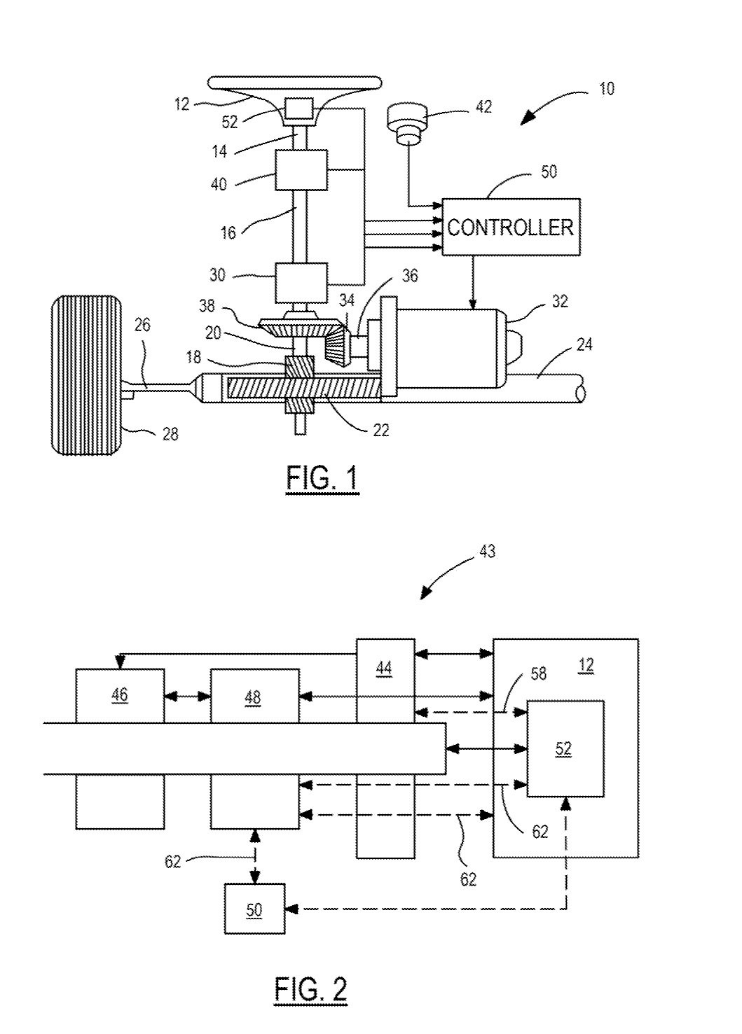

FIG. 1 is a block diagram of an example of a steering system 10 that incorporates a steering angle sensor and method of sensing a steering angle according to the inventive subject matter. The steering system includes a steering wheel 12 attached to a first end 14 of a steering column 16. A steering pinion gear 18, attached to a second end 20 of the steering column 16 opposite the first end 14, engages a steering rack gear 22 of a steering rack 24. Each end of the steering rack 24 includes a tie rod 26 attached to a steerable wheel and tire assembly 28 in a conventional manner. A steering torque sensor 30 may be incorporated into the steering column 16 for detecting a steering torque applied by a vehicle operator to the steering column 16 by way of the steering wheel 12. An electric motor 32 includes an output gear 34 that is mounted to an output shaft 36 for drivingly engaging an assist input gear 38 mounted on the steering column 16. It should, be noted that while a vehicle having an electrically assisted power steering (SPAS) is shown, the inventive subject matter is not limited to such a steering system.

The system 10 includes a steering column module 40 connected to the steering column 16. A vehicle speed sensor 42 is also shown. The steering column module 40, which, in one embodiment of the inventive subject matter may house parts of the steering angle sensor of the inventive subject matter, typically provides a steering angle signal 44 indicative of the relative rotational position of the steering column 16. The various signals generated by the system are fed to one or more controllers 50, or control modules, that may be associated with one or more vehicle control systems. The steering wheel 12 has a motor actuator 52 and associated electronics for controlling a motor (not shown) in the steering wheel 12. The steering column module 40 is shown as being attached to the steering column 16. In another embodiment of the inventive subject matter parts of the steering angle sensor are incorporated not only into the column module 40, but the actuator 52 in the steering wheel 12 as well. The embodiments of the inventive subject matter will be discussed in further detail with reference to FIG. 2.

FIG. 2 is a block diagram of the steering wheel 12 and the steering column 16 incorporating the steering angle sensor according to the inventive subject matter. FIG. 2 shows both the mechanical and electrical connections of the steering angle sensor. The mechanical connections between components are represented by solid arrow lines while the electrical connections, or signal, flow, are shown by dashed arrow lines. The steering angle sensor 43 has a first part 44, also called a rotor, which may be coupled mechanically to the steering wheel 12 or steering column 16. The steering angle sensor 43 has a second part 46, called a stator which is fixed or immobile in that it remains stationary and does not rotate with the steering column 16 or the steering wheel 12. The first part 44 rotates relative to the second part 46 as the steering wheel 12 or steering column 16 rotate.

The second part 46 may be fixed about the steering column 16 as shown in FIG. 2, or it may be fixed to a cross-car beam (not shown). The second part 46 of sensor 43 may also be incorporated into the column module (40 in FIG. 1). For example, the second part 46 may be housed, engaged, or attached to the column module. In either scenario, the second part 46 is immobile with respect to the rotating steering column 16 and/or steering wheel 12.

An electrical connection device 48 is arranged between the first part 44 and the steering wheel 12. The electrical connection device 48 may be a spirally wound, flexible electrical conductor, also known as a clockspring, for transmitting signal information, electrical currents and pulses to the steering wheel 12. The inventive subject matter is advantageous in that there is no need for a direct electrical connection between the first and second parts 44, 46 of the sensor 43. The second part 46, the static part, is typically a magnet. The first part 44, the rotating sensor part, is typically a hall effect sensor measuring a magnetic field generated by the magnet.

The first part, rotor, 44 of the sensor 43, as it rotates with the steering wheel 12 or steering column 16, scans the second part 46. The stationary second part 46 is a code carrier. The code may be embodied as a code disc, or the second part 46 may have the code embedded therein on a structure or housing of the second part 46. In the alternative, the second part 46 is embodied in the column module 40 as part of the column module's housing with the code embedded therein, such as on an inner wall of the column module housing 40.

In operation, the first part 44 rotates with the steering wheel 12 or steering column 16 and scans the code that is provided by the fixed second part 46 for determining a steering angle. The steering angle 58 from the first part 44 may be transmitted to the actuator 52 and to a controller 50 or other device associated with the controller. Additionally, the steering angle 62 may be transmitted through the clockspring 48 to the controller 50, the actuator 52 or the steering wheel 12. In any configuration, the steering angles 58, 62 may supplied directly to the actuator 52, which is also in communication with the controller 50. Electronics, not specifically shown in FIG. 2, are associated with the first part 44 for evaluating and generating the steering angle 58.

The inventive subject matter is advantageous in that the steering angle information 58 supplied by first part 44 or rotor, which is also the sensor portion or scanning device, may be provided directly to the steering wheel 12 of the motor vehicle, with a high refresh or data rate, high precision and/or a high load current. Further, because the first part 44 rotates with the steering wheel, the sensing portion or scanning device that is the first part 44, as well as the electronics associated with the first part, may be incorporated into the actuator 52, thereby reducing the number of parts needed for sensing a steering wheel angle.

Another advantage is that transmission, of the signal 62 may also come from the immobile second part 46 by way of the clock spring 48. While this configuration for the transmission is still possible, it is not necessary and typically comes at the cost of transmission losses. The steering angle signal 58 may be fed directly to the actuator 52 in a simple manner and without transmission losses which are typical in prior art steering angle sensors. In prior art steering angle sensors, the steering angle must be transmitted through the clockspring 48 into the steering wheel 12 or steering actuator 52 introducing transmission losses and adversely affecting the quality of the steering angle signal. The inventive subject matter overcomes this drawback associated with the prior art.

Another advantage of the inventive subject matter is that the second part 46, the stator that contains the code scanned by the first part 44, is not movable together with the steering wheel 12 or steering column 16. The immobile second part 46 forms the code carrier, the code of which may, for example, be applied to an inner wall of the second part 46. Further, as discussed above the fixed housing part 46 may be incorporated into the column module 40. In either scenario, because the code may be incorporated into the housing 46, a code disc, as conventionally used in prior art steering angle sensors, is not necessary in the sensor 43 of the inventive subject matter and therefore, may be omitted. The sensor 43 of the inventive subject matter is more compact as a result and thereby easier to install.

Yet another advantage of the inventive subject matter is that the first part 44 of the module may be incorporated into the actuator 52 whereby the electronics of the actuator 52 perform the scanning and evaluating functions associated with the first part 44 of the sensor 43. The inventive subject matter embodies an integration of the first part 44 of the sensor directly in the electronics of the actuator 52. Therefore, any evaluation electronics system that encompasses the scanning device may be arranged on a common printed circuit board of the actuator 52 which may be movable or rotatable with either the steering wheel 12 or the steering column 16 as shown.

In the foregoing specification, the invention has been described with reference to specific exemplary embodiments. Various modifications and changes may be made, however, without departing from the scope of the inventive subject matter as set forth in the claims. The specification and figures are illustrative, rather than restrictive, and modifications are intended to be included within the scope of the inventive subject matter. Accordingly, the scope of the invention should be determined by the claims and their legal equivalents rather than by merely the examples described.

For example, the steps recited in any method or process claims may be executed in any order and are not limited to the specific order presented in the claims. Additionally, the components and/or elements recited in any apparatus claims may be assembled or otherwise operationally configured in a variety of permutations and are accordingly not limited to the specific configuration recited in the claims.

Benefits, other advantages and solutions to problems have been described above with regard to particular embodiments; however, any benefit, advantage, solution to problem or any element that may cause any particular benefit, advantage or solution to occur or to become more pronounced are not to be construed as critical, required or essential features or components of any or all the claims.

The terms “comprise”, “comprises”, “comprising”, “having”, “including”, “includes” or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the inventive subject matter, in addition to those not specifically recited, may be varied or otherwise particularly adapted to specific environments, manufacturing specifications, design parameters or other operating requirements without departing from the general principles of the same.

1. A steering angle sensor comprising:
a first part engaged to and rotatable with a steering system;
a second part providing a code, the second part immovably engaged to the steering system, the first part rotates about the second part to scan the code; and
an electrical connection between the steering system and the second part that transmits an output signal upon the first part scanning the code, the output signal being representative of a steering angle.

2. The steering angle sensor as claimed in claim 1 wherein the steering system further comprises an actuator in a steering wheel and the first part is incorporated into the actuator.

3. The steering angle sensor as claimed in claim I wherein the first part is rotatably engaged to a steering column of the steering system.

4. The steering angle sensor as claimed in claim 1 wherein the first part is rotatably engaged to a steering wheel of the steering system.

5. The steering angle sensor as claimed in claim 1 wherein the steering system further comprises a column module and the second part is incorporated into the column module.

6. The steering angle sensor as claimed in claim 2 wherein the steering system further comprises a column module and the second part is incorporated into the column module.

7. The steering angle sensor as claimed in claim 2 wherein the electrical connection is a clockspring.

8. A steering angle sensor comprising:
an actuator in a steering wheel and rotatable with the steering wheel;
a fixed column module having a code, the actuator rotatably engages the fixed column module;
an electrical connecting device coupled between the actuator and the column module housing; and
electronics in the actuator for scanning the code as the actuator rotates with the steering wheel, receiving transmissions from the electrical connecting device a, evaluating the scanned code and outputting a steering angle signal.

9. The steering angle sensor as claimed in claim 8 wherein the electrical connecting device further comprises a spirally wound, flexible electrical conductor.

10. The steering angle sensor as claimed in claim 8 wherein the code is provided by a code disc in the fixed column module.

11. The steering angle sensor as claimed in claim 8 wherein the code is provided on a housing of the fixed column module.

12. The steering angle sensor as claimed in claim 11 wherein the code is provided on an inner wall of the housing.

13. A method for sensing a steering wheel angle for a steering system having an actuator in a steering wheel, the method comprising the steps of:
providing a code in a fixed column module;
scanning the code using the actuator wherein the actuator rotatably engages the fixed column module housing;
transmitting data on an electrical connection between the column module housing and the actuator;
generating a signal representative of a steering wheel angle using the transmitted data; and
outputting a steering angle signal.

14. The method as claimed in claim 13 wherein the step of providing a code in a fixed column module further comprises a code disc in a housing of the fixed column module.

15. The method as claimed in claim 13 wherein the step of providing a code in a fixed column module further comprises providing a code on a housing of the fixed column module.

16. The method as claimed in claim 15 wherein the step of providing a code in a fixed column module further comprises providing a code on an inner wall of the housing.

17. The method as claimed in claim 13 wherein the step of scanning the code using the actuator further comprises magnetic measuring.

18. The method as claimed in claim 13 wherein the step of scanning the code using the actuator further comprises optical measuring.
